(19) United States
(12) Patent Application Publication
(10) Pub. No.: US 2009/0327075 A1
(43) Pub. Date: Dec. 31, 2009

(54) Optimizing Advertisement Campaign Servicing

(75) Inventors: Saied Saadat, Watertown, MA (US); Yekesa Kosuru, Westford, MA (US)

Correspondence Address: DITTHAVONG MORI & STEINER, P.C., 918 Prince St., Alexandria, VA, 22314, US

(73) Assignee: NOKIA CORPORATION, Espoo (FI)

(21) Appl. No.: 12/147,991

(22) Filed: Jun. 27, 2008

(51) Int. Cl. G06Q 30/00

(52) U.S. Cl. 705/14.53; 705/14.55

(57) ABSTRACT

Methods, system and computer readable media for distributing advertisements include minimizing storage costs for frequency capping, dividing a set of campaigns into slices and predetermining campaign-target matches. Frequency storage costs may be minimized by storing frequency data for those users or groups of users that have a high probability of exceeding a frequency limit. Additionally or alternatively, a set of campaigns may be divided into slices. Less than all of the slices may then be evaluated (i.e., instead of the entire set) against a user requesting an advertisement. Still further, all campaign-target matches may be evaluated prior to receiving advertisement requests. Re-evaluations may be performed when changes occur to the set of campaigns. The match data may be stored in bitset, hash map and bitmap storage structures.

Aspects of the invention generally relate to distributing advertisements. In particular, aspects are directed to improving the efficiency and efficacy of serving advertisements.

### BACKGROUND

Advertising has become an increasingly important source of revenue in many industries. Electronic media and content providers, for example, rely heavily on advertising to be able to provide services to users for free or at a reduced cost. With increasing numbers of advertisers and increasing numbers of users, an advertising server must be able to process a significant amount of information quickly to provide advertisements within a reasonable amount of time while dealing with other issues such as ad fatigue. However, advertising servers often need to evaluate each advertisement campaign against a user each time an advertisement request is received, potentially leading to significant processing and response times. Additionally, to avoid ad fatigue, transmission counts are typically stored to make sure each campaign is not transmitted to a user too many times. Storing frequency information for each user-campaign pair can increase storage requirements exponentially as the number of advertisements or users increase.

### BRIEF SUMMARY

Aspects relate to comparing a set of advertisements to a set of users to predetermine user-campaign matches. Thus, when an advertisement request is received, an advertisement may be selected using the predetermined match data without having to evaluate the user against hundreds or thousands of advertisements while the user waits for a response to the request. According to one aspect, the match data may be stored in a bitset/hash map data structure where each user has a corresponding bitset that stores high and low bits in various positions to specify whether a match exists. Each position may correspond to a different advertisement campaign. The bitsets may be stored as a hash map that is keyed off of user identification information. Additionally, a bitset or bitmap may be used to identify which campaigns correspond to which positions in the bitset. A bitset or bitmap may further store advertisement objects so that the objects may be extracted directly from the bitmap instead of having to retrieve them from another location or device.

According to another aspect, frequency data indicating how often an advertisement campaign has been sent to a particular user may be stored based on a likelihood that the user or a group of users will exceed a frequency limit. Initially, users may be grouped according to usage patterns. A probability that an advertisement campaign will be sent to users of a group will exceed the frequency limit is determined. The probability may then be compared to a threshold probability to determine whether frequency data should be stored for the group and advertisement campaign pair. In one or more arrangements, an indicator may be used to identify to the advertisement server which campaign-user pairs are to have frequency data stored. In one or more configurations, the probability limit may be determined based on a confidence level specified by the advertisers according to their tolerance for fault.

According to yet another aspect, a set of advertisement campaigns may be divided into groups or slices to reduce the amount of processing needed to respond to an advertisement request. Advertisement campaigns may be divided using a variety of algorithms taking into account factors such as a target audience, the number of users matching a campaign and the like. When responding to an advertisement request, fewer than all of the slices may be selected for comparison to information about a user associated with the request. The selection of one or more campaign slices may be performed in various ways including randomly, based on a number of times previously selected and the like.

Still further, various combinations and sub-combinations of the campaign slicing, frequency capping and predetermining match data features may be used to further increase the efficiency and efficacy of advertisement servicing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Certain embodiments are illustrated by way of example and not limited in the accompanying figures in which like reference numerals indicate similar elements and in which:

FIG. 1 illustrates a block diagram of a communication network in which one or more embodiments may be implemented.

FIG. 2 illustrates a block diagram of a communication device according to one or more aspects described herein.

FIG. 3 is a flowchart illustrating a method for storing user-ad campaign match data according to one or more aspects described herein.

FIG. 4 illustrates hash map and bitmap data structures for storing user-ad campaign match data according to one or more aspects described herein.

FIG. 5 is a flowchart illustrating a method for dividing a set of advertisement campaigns into multiple groups according to one or more aspects described herein.

FIG. 6 is a flowchart illustrating a method for minimizing ad fatigue in an advertisement serving environment while minimizing storage requirements according to one or more aspects described herein.

FIG. 7 illustrates a storage format for storing frequency data for user-campaign pairs according to one or more aspects described herein.

FIG. 8 is a flowchart illustrating a method for distributing advertisement campaigns using frequency capping, predetermination of user-campaign matches and campaign slicing according to one or more aspects described herein.

FIG. 9 is a flowchart illustrating a method for distributing advertisements using frequency capping and pre-matching users and campaigns according to one or more aspects described herein.

FIG. 10 is a flowchart illustrating a method for using frequency capping in combination with campaign slicing in advertisement distribution according to one or more aspects described herein.

FIG. 11 is a flowchart illustrating a method for using campaign slicing in conjunction with campaign-target pre-matching in advertisement campaign servicing according to one or more aspects described herein.

FIG. 12 illustrates a block diagram of an advertisement server configured to distribute advertisement campaigns to client devices according to one or more aspects described herein.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

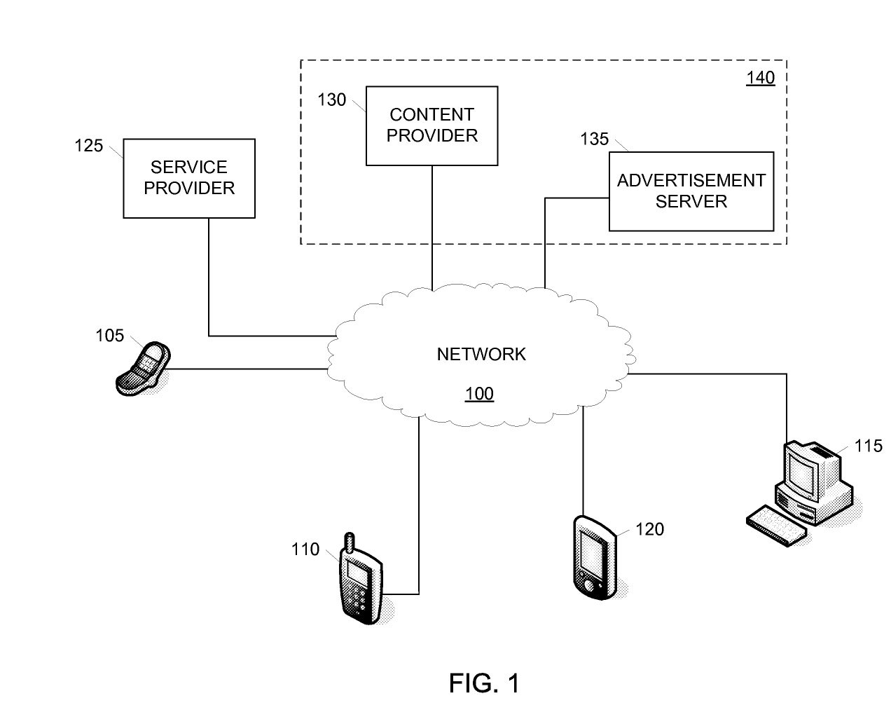

Various embodiments may be used in a broad array of networks and communication protocols. FIG. 1 illustrates an example of a communication network through which data may be exchanged according to one or more aspects described herein. Specifically, communication network 100 includes mobile communication devices 105 and 110, personal computer (PC) 115 and personal data assistant (PDA) 120, service provider 125, content provider 130 and advertisement server 135. PC, as used herein, is not limited to any particular operating system or platform. Communication through network 100 is not limited to the illustrated devices and may include other apparatuses such as a home video storage system, a portable audio/video player, a digital camera/camcorder, a positioning device such as a GPS (Global Positioning System) device or satellite, a mobile television, a STB (Set-top Box), a digital video recorder, and the like and in any combination of the aforementioned.

Various types of content and service providers may be included in the network including service provider 125, content provider 130 and advertisement server 135. Service provider 125 may be configured to provide wireless communication services or data connection access for devices 105, 110, 115 and 120 while content provider 130 may be configured to store and deliver various types of content including web pages, video, audio, text and the like. Advertisement server 135, on the other hand, may be used to deliver advertisements to users and devices such as devices 105, 110, 115 and 120. For example, advertisement server 135 may operate in conjunction with content provider 130 to deliver advertisements as part of the content provided by content provider 130. In various configurations, one or more of advertisement server 135, content provider 130 and/or service provider 125 may be incorporated into a single device or system. System 140 is one example of an entity that incorporates both content provider 130 and advertisement server 135.

Devices 105, 110, 115 and 120 may be connected to each other through various types of networks. For example, mobile communication devices 105 and 110 may communicate with one another through a cellular network, a short range communication connection (such as a Bluetooth®, UWB (Ultra Wide Band), infrared, WiBree), a wireless local area network (WLAN) or a high-speed wireless data network, e.g., Evolution-Data Optimized (EV-DO) networks, Universal Mobile Telecommunications System (UMTS) networks or Enhanced Data rates for GSM Evolution (EDGE) networks. In one or more arrangements, mobile communication devices 105 and 110 and other devices like PC 115 and PDA 120 may communicate through a wired network. Further, devices 105, 110, 115 and 120 may use various communication protocols such as Internet Protocol (IP), Transmission Control Protocol (TCP), Simple Mail Transfer Protocol (SMTP) among others known in the art.

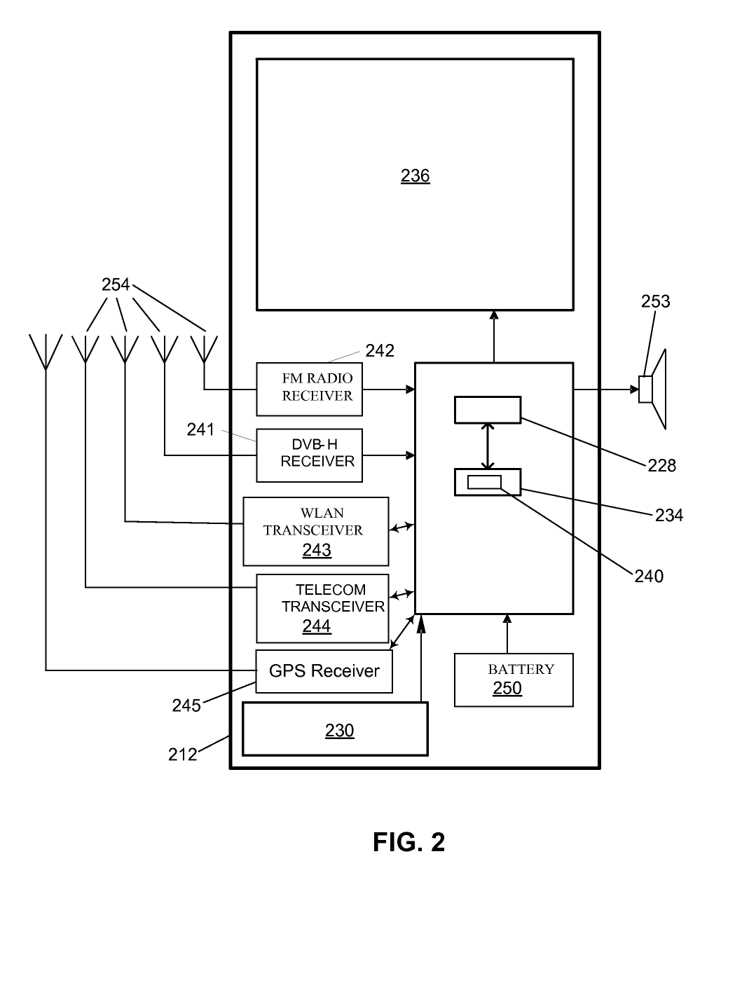

FIG. 2 is a block diagram of a communication device such as mobile communication device 105 including processor 228 connected to user interface 230, memory 234 or other storage, and display 236. Communication device 212 may also include battery 250, speaker(s) 253 and antennas 254. User interface 230 may further include a keypad, touch screen, voice interface, one or more arrow keys, joy-stick, data glove, mouse, roller ball, or the like. Communication device 212 may comprise a computer, PDA, mobile telephone and the like. User interface 230 may be configured to receive user input, e.g., corresponding to a selecting a user profile (as discussed in further detail below).

Computer executable instructions and data used by processor 228 and other components within communication device 212 may be stored in a computer readable memory 234. Memory 234 may further store various data such as user profiles, usage history or statistics, product recommendations and the like. The memory may be implemented with any combination of read only memory modules or random access memory modules, optionally including both volatile and nonvolatile memory. Software 240 may be stored within memory 234 or storage to provide instructions to processor 228 for enabling communication device 212 to perform various functions. Alternatively, one or more modules of communication device 212 may be embodied in hardware or firmware (not shown).

Communication device 212 may be configured to receive, decode and process digital radio or television broadcast transmissions that are based, for example, on the DVB (Digital Video Broadcasting) standards, through a specific DVB receiver 241. The mobile device may also be provided with other types of receivers for digital broadcast transmissions, such as ATSC (Advanced Television Systems Committee), MediaFLO, DMB (Digital Multimedia Broadcasting), ISDB (Integrated Services Digital Broadcasting), HDTV (High-definition television), DAB (Digital Audio Broadcasting), DRM (Digital Radio Mondiale), etc. Additionally, communication device 212 may also be configured to receive, decode and process transmissions through FM/AM Radio receiver 242, WLAN transceiver 243, and wireless telecommunications transceiver 244. Transceivers 243 and 244 may, alternatively, be separated into individual transmitter and receiver components (not shown). In one example, transceiver 244 may include a broadcast receiver (not shown) and a backward channel receiver (not shown) for communicating over the broadcast channel and the backward channel, respectively. Additionally, communication device 212 may further include a navigation engine for determining a position of communication device 212. In one example, the navigation engine may include Global Positioning System (GPS) receiver 245 for receiving position information from a GPS satellite (not shown). The receiver and transmitter components, e.g., transceiver 244, may be configured to transmit user input and other data (e.g., user selections of profiles, purchase requests, requests for information, user behavior/actions, etc.) to a server and receive data such as product recommendations, price quotes, user profile information and the like from the server.

According to one aspect, communication device 212 may receive Radio Data System (RDS) messages. Other transmission and reception systems may also be used including BLUETOOTH®, WiMAX (Worldwide Interoperability for Microwave Access) i.e., Institute of Electrical and Electronics Engineers (IEEE) 802.16 standard, or UWB (Ultra-wideband) transceivers. In one or more instances, signals may be transmitted to and received from another mobile terminal (not shown). For example, audio, video and other signals may be transmitted between two communication devices using various transmissions protocols such as wireless local area networks (WLANs), General Packet Radio Service (GPRS), third generation mobile system technology (3G), Bluetooth or Universal Plug and Play (UPnP). Such networks may be used to access or support local networks or remote networks such as the Internet.

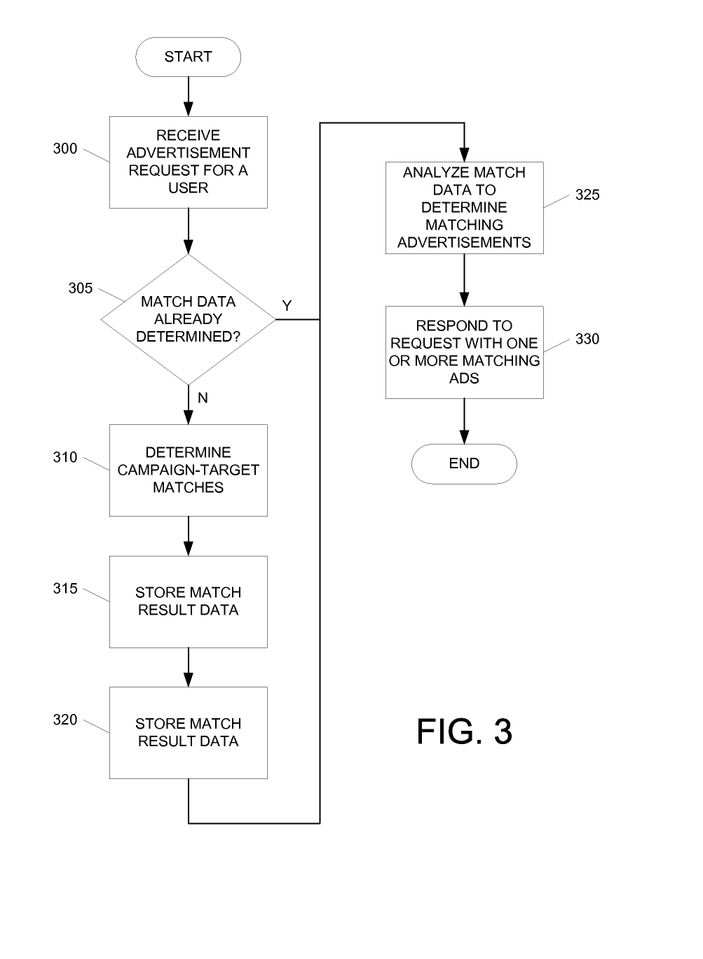

With more devices such as device 212 of FIG. 2 having network capabilities, increasing attention is being paid to advertising to users of such devices. Increasing attention often leads an increasing number of advertisements and increased load and response times on advertising servers. FIG. 3 is a flowchart illustrating a method for determining advertisements campaign target matches and storing match data to help minimize loads and response times when responding to advertisement requests. An advertisement campaign may include one or more advertisements that share an association with a particular product, company, purpose or the like. An advertisement campaign may further specify attributes such as a distribution plan including scope (i.e., how many times the advertisement is to be transmitted in a specified period of time), size of advertisements, target user characteristics and the like.

In step 300, an advertisement server (e.g., server 135 of FIG. 1) may receive an advertisement request for a user. The request may include identification information such as a username, demographic information, information about a device being used by the user and the like. In step 305, the advertisement server may determine whether advertisement campaign target matches have already been determined for a current set of advertisements and campaigns. Campaign target matches generally refer to matches between an advertisement campaign and one or more users or other entities (i.e., targets). If not, the advertisement server may determine campaign target matches by comparing one or more of the advertisement campaigns against each user in a set of users in step 310. For example, the advertisement server may compare users' personal, demographic or other information with target parameters specified by an advertisement or campaign. According to one aspect, advertisement/campaign target matches might only be determined if matches have not already previously been determined for one or more advertisements or campaigns in the current set. Thus, matches might only be determined at a predetermined time (e.g., before receiving any requests) and when new advertisements or campaigns are added. By only determining matches when matches have not been determined for one or more campaigns of a current set of advertisements, an advertisement server may improve efficiency by reducing processing and response times.

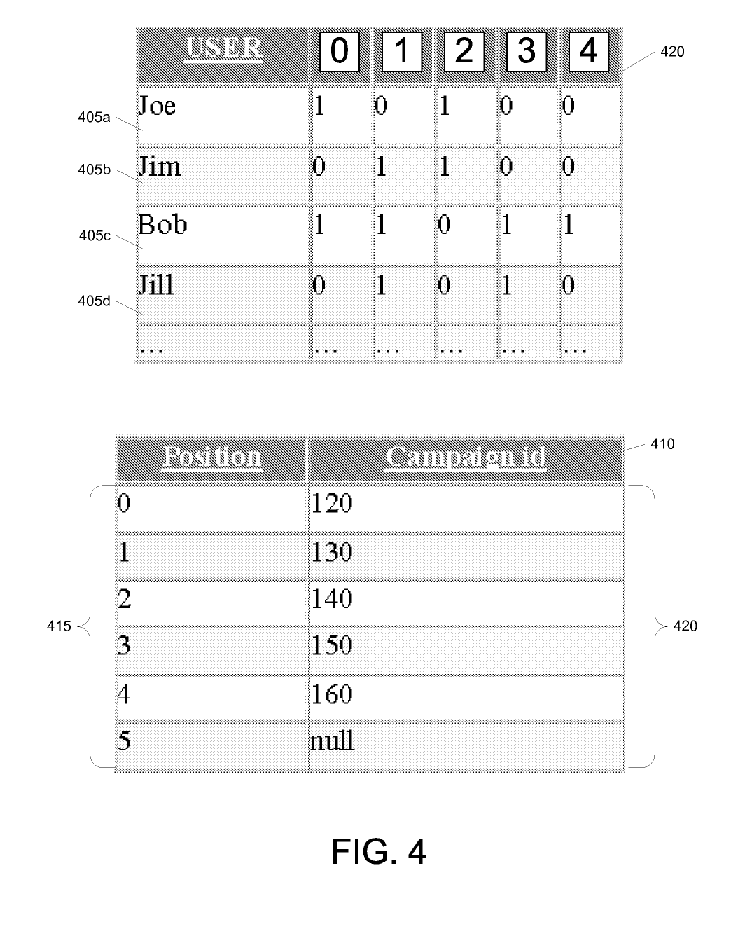

Once the match results have been determined, the result data may be stored at the advertisement server in step 315. A variety of data storage structures may be used. In one configuration, result data may be stored in bitset or bitmap data structures. FIG. 4 illustrates bitset data structures 405a-d and bitmap data structure 410 configured to store match result data. Each bitset 405a-d is configured to match information for a single user identified by a username or other user identification (ID). Each bitset 405a-d may further include a set of bits signifying whether a match was made with an advertisement. That is, positions 0-4 may each represent a different advertisement campaign. A value of ‘1’ in a position may indicate that a match exists while a value of ‘0’ may indicate that a match between the user and the campaign or advertisement corresponding to the position does not exist. Other values, symbols or text besides ‘0’ and ‘1’ may also be used to indicate matches and non-matches. In one or more configurations, bitsets 405a-d may be stored as a hash map 420 that is keyed off user identification information (e.g., a unique name or subscriber ID). That is, a bitset entry in hash map 420 may be located by using user identification information as a key.

In some instances, the positions of campaigns in bitsets 405a-d may change. For example, if a campaign is deleted and a new one added to the deleted campaign's previous position, that position would correspond to the new campaign. To track the campaign-position correspondence, bitmap 410 may be used. In particular, bitmap 410 is configured to store position numbers 415 in association with campaign or advertisement identifiers 420. Thus, to identify a campaign or advertisement that matches a user, an advertisement server or other entity may determine the position in which a match was indicated using one of bitsets 405a-d and lookup the corresponding campaign or advertisement using bitmap 410.

Using bitsets 405a-d/hash map 420 and bitmap 410, advertisements may be removed or added. For example, to remove an advertisement campaign, bitmap 410 may be modified to remove the corresponding campaign or advertisement ID. In some instances, the removed ID may be replaced by an indicator, e.g., “NULL,” that signifies that the position is open. Additionally and optionally, the corresponding bit in each bitset 405a-d may be turned to ‘0’ indicating no match. If, however, an advertisement or campaign is being added, bitmap 410 may be searched for an open position. For example, an open position may be a position having the “NULL” indicator or a new position in the bitmap. Once found, the parameters or criteria specified by the new advertisement or campaign may be compared against each of the users in bitsets 405a-d and the bit for the open position is set according to whether a match is determined to exist. Additionally, the open position in bitmap 410 may be filled with the advertisement or campaign information of the new advertisement or campaign.

Referring again to FIG. 3, upon determining and storing the match data or determining that the match data has already been evaluated, the advertisement server may identify and retrieve match data corresponding to the user for which the advertisement is requested in step 320. For example, in a configuration where match data is stored as user-advertisement bitsets (e.g., bitsets 405a-d of FIG. 4) in a hash map, a bitset corresponding to the user may be identified by using identification information of the user as a hash map key. In step 325, the advertisement server may then analyze the match data to determine the advertisements or campaigns that match the user for which the advertisement is requested. In the above example using bitsets, the advertisement server may identify the position(s) in the bitset associated with the user that indicate a match. The advertisement server may subsequently determine the advertisements or campaigns corresponding to each identified match position using a campaign position map such as bitmap 410 of FIG. 4. In step 330, the advertisement server may respond to the request with one or more of the determined advertisements.

While the above method of FIG. 3 has been described as determining and storing match data in response to a request, match data may be determined and stored prior to or independent of receiving an advertisement request.

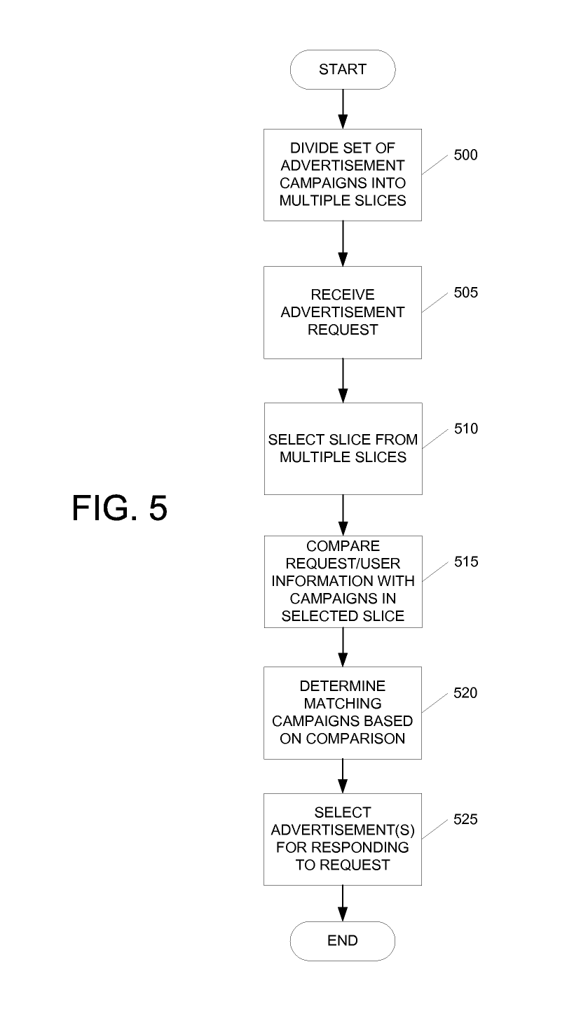

As a further or alternative method of increasing advertisement distribution efficiency, an advertisement server may use advertisement campaign slicing to reduce the number of advertisement campaigns that are evaluated when responding to an advertisement request. FIG. 5 is a flowchart illustrating a campaign slicing method for distributing advertisements according to one or more aspects described herein. In step 500, a set of campaigns is divided into multiple groups or slices. As a result, each slice or group will typically include a subset of advertisements or campaigns that are to be distributed by an advertisement server. A set of advertisements or campaigns may be divided into multiple slices in a variety of ways and using various algorithms. In one arrangement, slices may be formed to equalize an estimated average number of campaigns in a slice that will match a request. Such an estimate may be determined based on factors such as a designated run time of an advertisement campaign (e.g., number of hours or minutes that the campaign has to run), potential number of targets for an advertisement campaign and a number of impressions that the campaign is specified to serve. Additionally, each slice or group of advertisement may be distinct from each of the other slices or groups and may include a number of advertisements less than the total number of advertisements in the set. Impressions, as used herein, refer generally to a number of times an advertisement is shown or distributed (or is believed to have been shown or distributed) to users. In some instances, an advertisement that is distributed may be shown more than once.

Once the advertisement campaigns have been divided into one or more campaign slices, an advertisement server may receive an advertisement request in step 505. The request may include information specifying a user for which the advertisement is being requested. In step 510, a slice may be selected from the multiple campaign slices. Slices may be selected in various ways including randomly, based on a rotation of slices, the number of times each slice has been selected and the like. Upon selecting a slice, information about the user or users for which the advertisement is being requested may be compared with the parameters of each advertisement campaign in the selected slice in step 515 to determine one or more matching advertisement campaigns in step 520. One or more of the matching advertisement campaigns may then be selected for responding to the request in step 525. The one or more advertisement campaigns that are selected for responding to the request may be selected in various manners including randomly, a number of times the campaign has been selected and/or combinations thereof.

According to one or more aspects, multiple slices may be selected and evaluated in sequence, against the request. Subsequent slices are selected and evaluated if the server does not find an appropriate campaign to serve from for the request in the initially or previously selected slice. For example, a campaign distribution system may initially select slice A from which to select a campaign for a requesting user. Upon determining that no suitable or appropriate campaign for the requesting user, the campaign distribution system may proceed to select slice B and so on until an appropriate or suitable campaign is found for the user. This allows an advertisement server to respond to a request in a shorter amount of time than if the server analyzed every campaign that it serves.

In addition to long processing and response times, ad fatigue is another concern that can affect the effective distribution of advertisement campaigns. Ad fatigue is a phenomenon that occurs when a particular user is shown the same advertisement a number of times causing the user to become tired of seeing the ad. Ad fatigue may begin reflecting negatively on the product or service advertised. However, to combat ad fatigue, the frequency with which advertisements are delivered to a user must be recorded. With an increasing number of advertisement campaigns and users, the storage space needed to keep such records and the resources needed to enforce such restrictions may quickly become impractical.

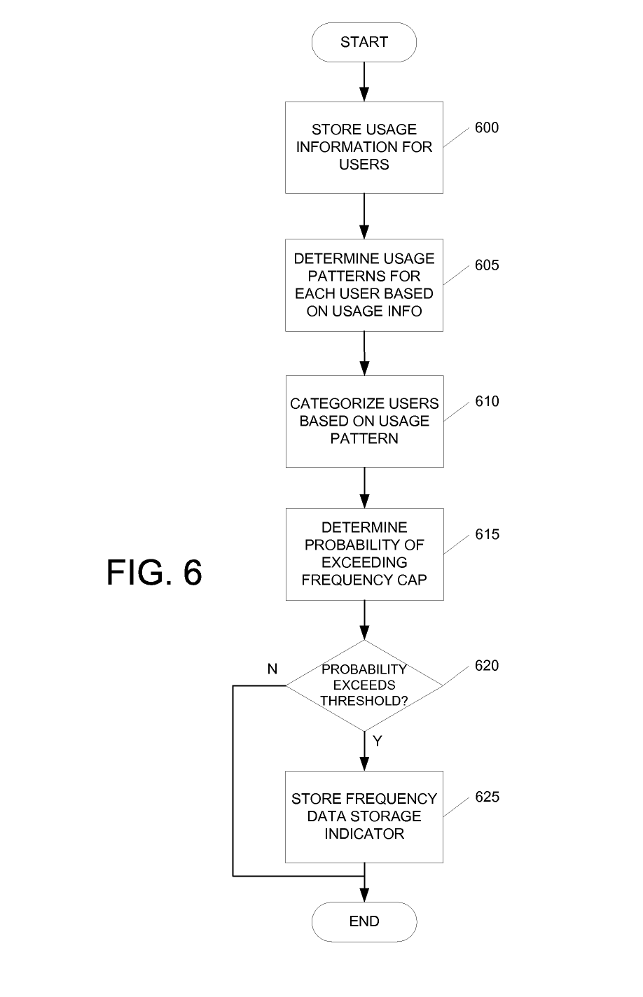

FIG. 6 illustrates a method for minimizing ad fatigue in an advertisement serving environment while minimizing storage requirements according to one or more aspects described herein. In step 600, usage information may be stored for a set of users (e.g., subscribers of a service) known to an advertisement server. Usage information may include times of day during which a user accesses a service or uses a certain feature designed to trigger advertisement distribution, a duration of such use, user interests, friends or contacts with which the user communicates and the like. In step 605, usage patterns may be determined for each user based on the stored usage information. For example, an advertisement server may determine, based on historical usage data, that a user regularly accesses science fiction related websites for at least 1 hour each day. Upon determining a usage pattern for each user, the users may subsequently be categorized or grouped based on those determined usage patterns in step 610. According to one example, all users that browse the web for at least 3 hours a day may be categorized into one usage pattern group. In another example, all users that spend a majority of time using instant messaging may be categorized into one category.

In step 615, a probability that users of a group or category will reach a frequency threshold or cap for an advertisement campaign over a specified period of time may be determined. Such a probability may be calculated in various ways and taking into account factors such as a number of similar advertisement campaigns and an average number of advertisements sent to a user in a particular usage group over the specified period of time. For example, a probability may be determined based on a number of times an advertisement campaign was distributed or shown to a user in the past over the same or similar period of time. The probability calculation may be based on the historical distribution data of the specific advertisement or may be based on data of a similar advertisement.

Once the probability for the group-campaign pair has been determined, an advertisement server may determine whether the probability exceeds a threshold probability in step 620. In one or more arrangements, the threshold probability may be defined based on a specified level of confidence. For example, an advertisement server may be instructed to prevent ad fatigue with a 95% level of confidence. The 95% level of confidence may be used to determine a corresponding probability threshold for which there would only be a 5% chance of an ad to be served to the same user more than the specified, i.e. acceptable, number of times over the specified period of time. Further, different probability thresholds may be defined for different usage pattern categories or, alternatively, the same probability threshold may be used across the board. In one example, simulations may be performed using historical distribution data to identify a probability threshold where the frequency caps are exceeded with the specified level of confidence. In particular, if the level of confidence is 90%, the simulation will identify the user (or user category) and campaign combinations that will have 10% or more chance of exceeding the frequency restrictions, if not explicitly enforced.

In step 625, an indicator that frequency data is to be stored for each user in the group of users with respect to the advertisement campaign may be stored. Alternatively or additionally, a frequency data entry may be created for each user-campaign pair (i.e., an entry for the advertisement and each user of the group) and/or an indicator not to store frequency data may be stored. Thus, when responding to advertisement requests, an advertisement server may determine whether to store frequency data for a selected campaign based on the existence or absence of a storage or non-storage indicator, the existence or absence of a frequency data entry or combinations thereof. Steps 615-625 may be repeated for each advertisement campaign/user group pair.

In one illustrative example, suppose that advertisement campaign distribution to a user Joe for the month of April is tracked and logged. Further suppose that Joe is served with an ad from a campaign such as Campaign A at the following times and days as shown below.

April 1->14:32, 15:15, 16:45 . . . , 20:19

April 2->10:12, 12:30, . . .

April 3->8:30, 15:13, . . .

April 30->9:46, 10:08, . . .

Using statistical methods and formulas, the probability of Campaign A being served to user Joe N times or less (or more) for any interval of time may be determined. For instance, the number of times that Campaign A will be eligible (i.e., not exceed distribution limitations) to be served to Joe in a T hour interval of time may be statistically calculated. T represents a frequency cap scope, while N represents a frequency cap value and X represents the confidence that the frequency cap will not be exceeded. In one example a campaign called “Product 1” may be assigned an hourly frequency capping that is set to 5. An ad server or company may further want to be 95% sure that the specified frequency cap is not exceeded. In order to decide whether to store frequency capping information or even test for it, an advertisement distribution system may determine if the system can be 95% sure that Campaign “Product 1” will not be chosen for serving to Joe (or a group of people like Joe) more than 5 times in any one hour interval (e.g., using the simulation methodology discussed above). If the answer is yes, the frequency capping for Joe will not be stored and checked. On the other hand, if no, frequency information and capping may be stored and/or checked.

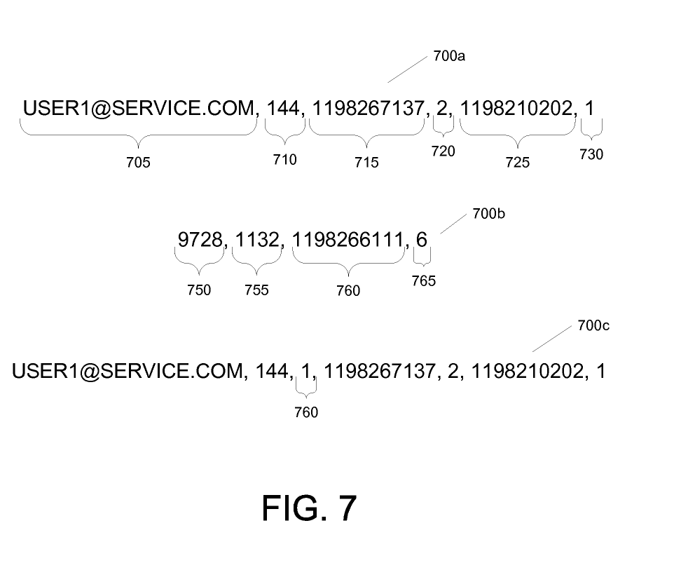

FIG. 7 illustrates a storage format for storing frequency data for campaign-target pairs according to one or more aspects described herein. For example, campaign-target pair 700a may include a user ID 705, campaign ID 710, first scope start time 715, first scope count (i.e., frequency) 720, second scope start time 725 and second scope count 730. In contrast, campaign-target pair 700b may include user ID 750, campaign ID 755, scope start time 760 and scope count 765 if only one scope is defined for the campaign corresponding to the specified campaign ID. Start times 715, 725, 750 may be expressed in a variety of ways including a number of minutes, seconds, hours, days, months from a predefined time, a specific date and/or time and the like. Campaign-target pair 700c may include some of the same information as campaign-target pairs 700a and b and in addition, include a frequency data storage indicator 760. An indicator value of ‘1’, for example, may represent that frequency data is stored or to be stored for that campaign-target pair (i.e., pair 700c) while a value of ‘0’ may represent that frequency data is not stored or to be stored. Other indicators and indicator values may similarly be used.

Alternatively or additionally, users might not be grouped or categorized according to usage pattern. Instead, the users may be evaluated on an individual basis. Whether categorization is used or not may depend on the number of users serviced by the advertisement server and a number of advertisement campaigns being served. Further, frequency caps or thresholds may be specified for multiple periods of times or scopes. For example, a company associated with an advertisement campaign may request that the advertisement campaign be distributed no more than 10 times to the same user in the same week and no more than 30 times over the course of a month. Thus, in some scenarios, a probability may be determined for whether a user or group of users will reach multiple frequency caps for multiple scopes. For instance, in the above example, if the confidence of meeting the frequency caps in either or both weekly and monthly scopes is less than the specified level, then the frequency cap information is stored and checked for both scopes or just the ones that do not satisfy the specified confidence level.

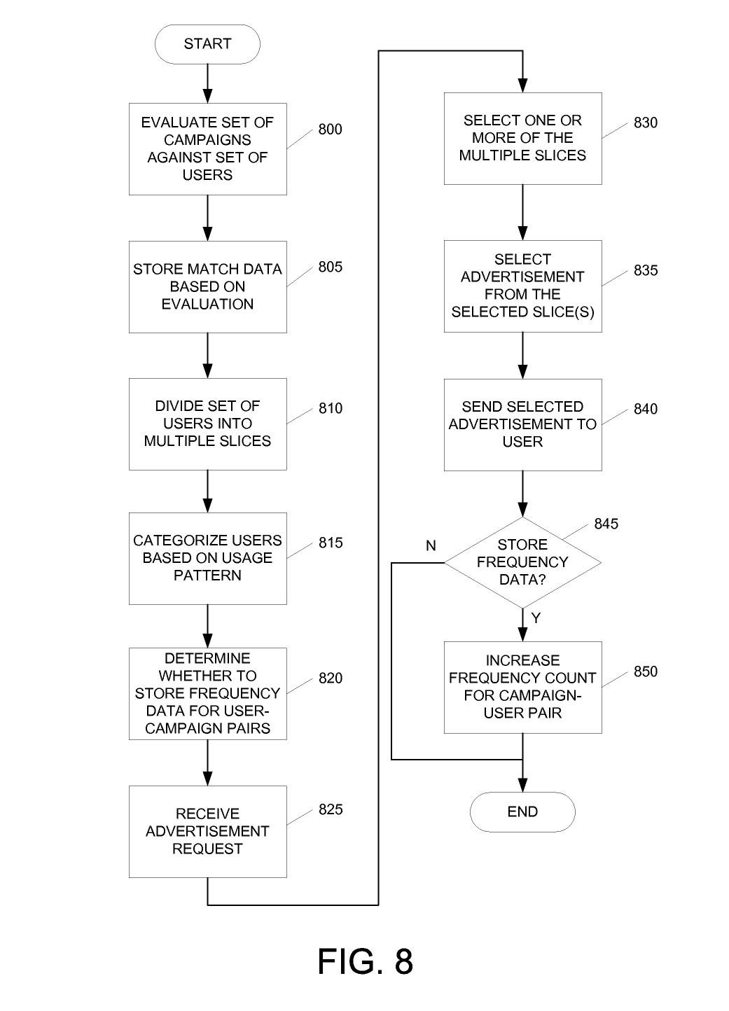

Various combinations of the methods and features of FIGS. 3, 5 and 6 may be used to further reduce processing times, load and ad fatigue. For example, FIG. 8 illustrates a method for using campaign slicing in conjunction with pre-matching of campaigns to targets and frequency capping to distribute advertisements according to one or more aspects described herein. In step 800, a set of campaigns may be evaluated against a set of users (e.g., step 310 of FIG. 3) to determine one or more campaign-target matches. The determined match data may then be stored in step 805. For example, the data may be stored in hash map/bitmap data structures as described in FIG. 4. In step 810, the set of campaigns may be sliced into multiple groups or slices. The slices or groups may be sized according to a variety of factors including those described with respect to step 500 of FIG. 5. In step 815, the set of users may also be grouped or categorized according to usage patterns (e.g., step 610 of FIG. 6). Additionally, an advertisement server may determine whether to store frequency data for each user-campaign pair based on a probability that each category of users will meet a specified frequency cap for an advertisement campaign in step 820 (e.g., steps 615-625).

In step 825, an advertisement server may receive an advertisement request for a user. The advertisement server may select one or more slices of the multiple slices (e.g., step 510) from which to select an advertisement campaign in step 830. The number of slices selected may be less than the total number of available slices. In step 835, an advertisement may be selected from the one or more selected slices with which to respond to the advertisement request. Selection of the advertisement may be performed in a manner similar to that described in steps 320-330 of FIG. 3. Additionally or alternatively, the advertisement campaigns available for selection in the one or more selected slices may be initially evaluated to identify campaigns that have exceeded a frequency cap limit for the user. For example, an advertisement server may compare a stored campaign-target distribution frequency with a frequency limit to determine if the limit has been met. If multiple scopes are defined, the frequency data and limits with respect to each scope may be evaluated. Campaigns that have exceeded the cap for the user may be eliminated from selection consideration. Advertisement campaigns for which frequency data is not stored or for which the cap or limit has not been reached for the user may be made available for selection. The selected advertisement may then be sent to the requesting user or device in step 840. In step 845, the advertisement server may determine whether to store frequency data for the campaign-group pair. If so, a frequency count for the campaign-group pair may be increased in step 850.

In other examples and configurations, various sub-combinations of the frequency capping, campaign slicing and pre-matching features may be used. For example, frequency capping may be used with campaign slicing or pre-matching and campaign slicing may further be combined with campaign-target pre-matching.

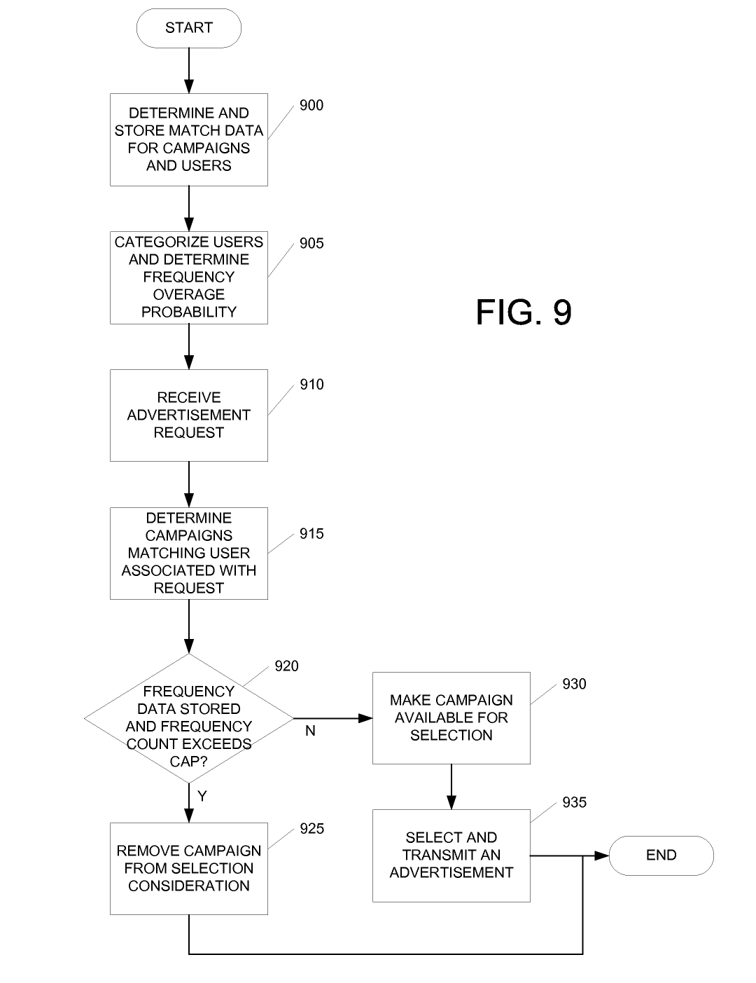

In one configuration, an advertisement server may use both frequency capping storage techniques in addition to the predetermination of campaign target matches to reduce storage requirements and processing and response times. A method for using frequency capping storage features with pre-matching of campaigns and users is illustrated in FIG. 9. In step 900, an advertisement server may initially determine and store match data for a set of advertisements and a set of users, e.g., according to the methods and features of FIG. 3. User categorization based on usage patterns and determination of a probability that a group of users will exceed a frequency cap (e.g., according to the methods and features of FIG. 5) may be performed in step 905. In step 910, an advertisement request for a user may be received. In response, the advertisement server may determine a set of one or more advertisements that match the user's information (e.g., demographics) using the stored pre-match data in step 915. In step 920, for each advertisement campaign in the determined set of advertisement campaigns, the advertisement server may determine whether frequency data exists for the advertisement campaign-user pair and whether the frequency data exceeds a frequency cap. If so, the advertisement campaign may be removed from selection consideration in step 925. If however, frequency data is not stored for the advertisement campaign or the frequency data does not exceed the frequency cap, the advertisement campaign may be made available for selection in step 930. In step 935, an advertisement may then be selected from the set of campaigns available for selection and transmitted to the user. Additionally, frequency data may be stored if needed.

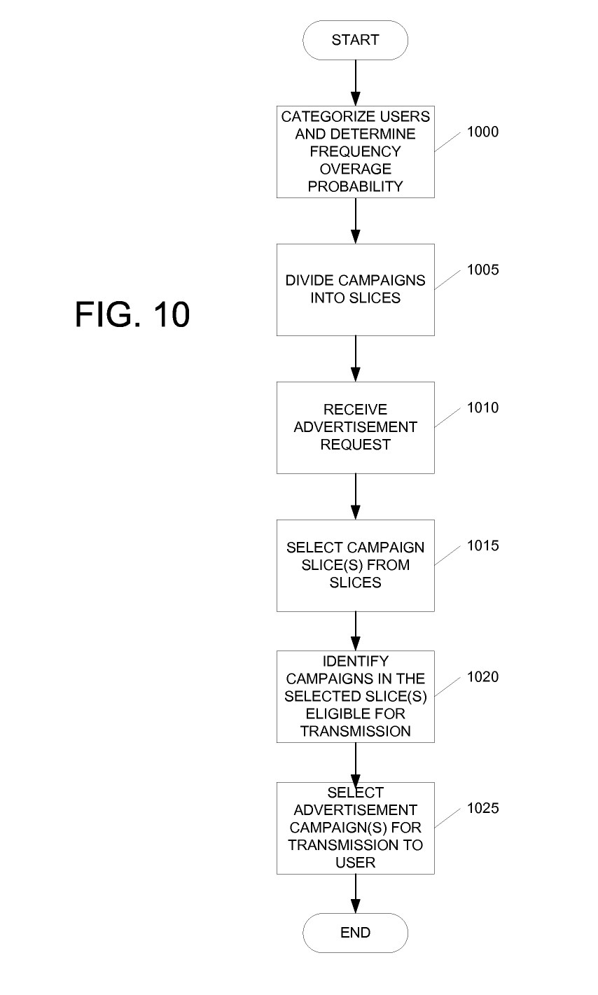

FIG. 10 illustrates a method for using frequency capping in combination with campaign slicing in advertisement distribution according to one or more aspects described herein. In step 1000, an advertisement server may categorize users based on usage patterns and determine of a probability that each group of users will exceed a frequency cap (e.g., according to FIG. 5). In step 1005, a set of campaigns may be divided into multiple slices. In step 1010, a request may be received for an advertisement for a user. In step 1015, the advertisement server may select a campaign slice from the multiple slices. The selection may be random or based on one or more selections rules. Upon making the selection, the advertisement server may identify advertisement campaigns in the selected campaign slice or slices eligible to be selected for transmission to the requesting user or device in step 1020. Eligibility for selection may be determined based on whether a frequency cap has been exceeded for a user-campaign pair (e.g., steps 920-930 of FIG. 9). In step 1025, one or more advertisement campaigns may be selected from the set of eligible campaigns and sent to the requesting user or device. Optionally, a frequency count may be increased for the user-campaign pair, if necessary.

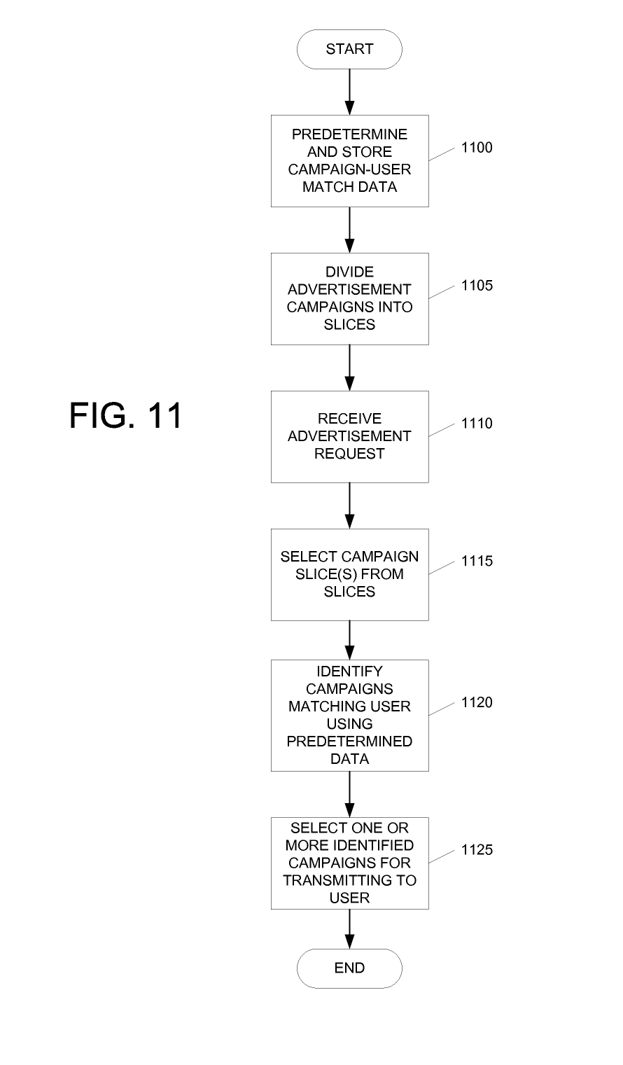

FIG. 11 illustrates a method for using campaign slicing in conjunction with campaign-target pre-matching according to one or more aspects described herein. In step 1100, an advertisement server may predetermine and store campaign-user match data for a set of advertisement campaigns and a set of users, e.g., as described in FIG. 3. Additionally, the advertisement server may divide the set of advertisement campaigns into multiple slices or groups in step 1105. In step 1110, the advertisement server may receive a request for an advertisement for a user. In response, the advertisement may select one or more of the campaign slices in step 1115. Upon selecting the one or more campaign slices, the advertisement server may then use the pre-match data determined and stored in step 1100 to identify campaigns that is considered a match for the user in step 1120. For example, the advertisement server may use hash map and bitmap data structures to identify a set of matching bits in a bitset corresponding to the user. Subsequently, each matching bit may be matched to a campaign based on the bit's position in the bitset. In step 1125, one or more of the matching campaigns may be selected for transmitting to the requesting user or device. According to the above bitmap/hash map example, an advertisement object corresponding to the selected campaign may be stored in and extracted from a bitmap storing bit position-campaign correspondence information.

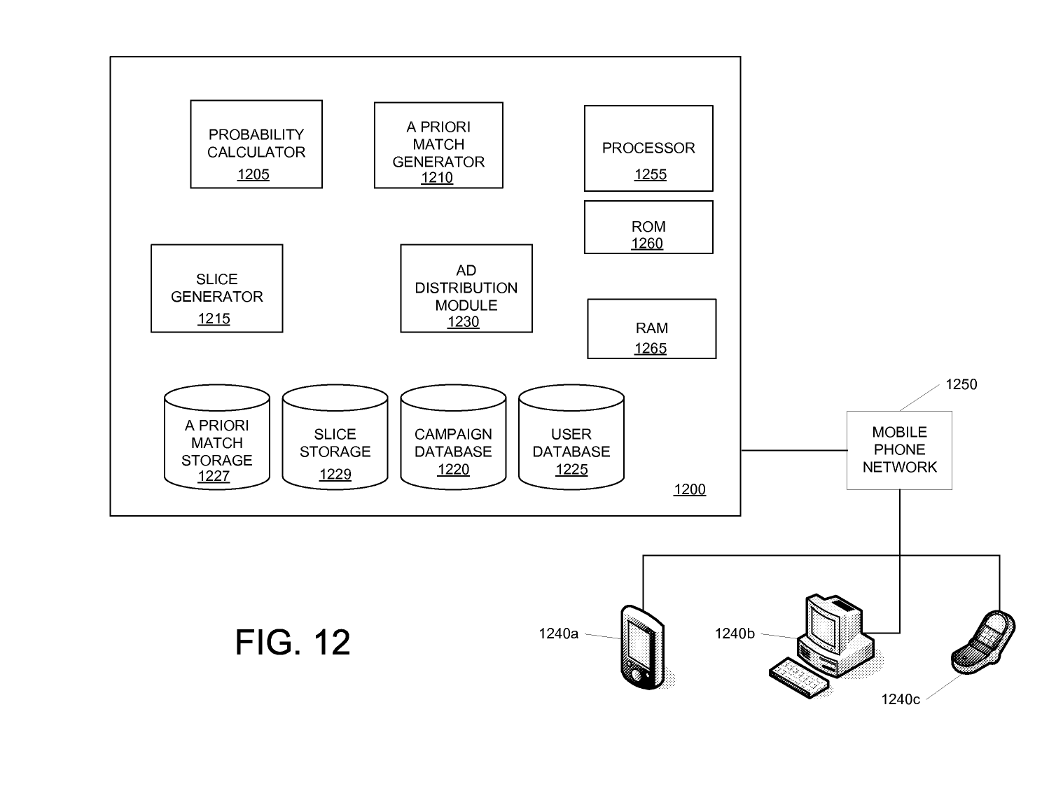

FIG. 12 is a block diagram of an advertisement server in communication with one or more client communication devices according to one or more aspects described herein. In particular, advertisement server 1200 includes components such as frequency cap probability calculator 1205 configured to determine a probability that a user or group of users is likely to exceed a campaign transmission frequency limit, a priori match generator 1210 configured to predetermine campaign-target matches and slice generator 1215 configured to divide a set of campaigns into multiple subsets. Data may be stored in a various storage devices and modules including a campaign database 1220 configured to store advertisement campaign information (e.g., an advertisement, a scope, delivery requirements), user database 1225 configured to store user and account information and a priori match storage configured to store the results of the campaign-target match determination, slice storage database 1227 configured to store campaign slices and a priori match storage 1229 configured to store predetermined match data. Advertisement server 1200 may further include an advertisement campaign distribution module 1230 configured to receive and respond to requests according to one or more methods, systems and features described herein. For example, distribution module 1230 may include a transceiver and/or network adapter configured to send and receive communications with clients 1240a-c through mobile communication network 1250. Server 1200 may generally include one or more processors (e.g., processor 1255) and memory such as read-only memory (ROM) 1260 and random access memory (RAM) 1265 configured to store computer readable instructions for performing any or all of the method steps described previously. Additionally or alternatively, the various modules and calculators (e.g., probability calculator 1205, match and slice generators 1210 and 1215 and distribution module 1230) may comprise computer software that is stored in ROM 1260 or RAM 1265 and executed by processor 1255, hardware, firmware and/or combinations thereof.

While some of the features have been described with respect to the transmission of a single advertisement in response to an advertisement request, similar features may be used to transmit multiple advertisements at one time. Thus, instead of identifying a single matching advertisement campaign, a system may determine multiple matching advertisement campaigns and transmit all of the determined campaigns to a user at the same time. The number of campaigns that a user may receive may depend on a service agreement, preferences of the user and/or parameters of an application through which the advertisements are displayed.

The methods and features described herein may also be selectively applied and used based on various factors. For example, methods and features of frequency capping and data storage as described herein might only be used where a percentage of advertisement campaigns with frequency caps is greater than a specified percentage threshold (e.g., 75% or 90%). In another example, campaign-user matches might only be predetermined or precomputed in situations where there are a relatively small number of campaigns (e.g., 10,000). In yet another example, campaign slicing might be used only in situations where the number of campaigns exceeds a threshold, e.g., 1,000, 10,000 or 100,000.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions or other data stored in a read only memory (ROM). In some such embodiments, the ROM stores programming instructions that cause the IC to perform operations according to one or more of the methods described herein. In at least some other embodiments, one or more the methods described herein are hardwired into an IC. In other words, the IC is in such cases an application specific integrated circuit (ASIC) having gates and other logic dedicated to the calculations and other operations described herein. In still other embodiments, the IC may perform some operations based on execution of programming instructions read from ROM or RAM, with other operations hardwired into gates and other logic of IC. Further, the IC may output image data to a display buffer.

The term “processor” or “processors” in combination with memory should be understood to include any of the foregoing combinations of hardware or software to carry out steps or functions.

Although specific examples of carrying out the invention have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

We claim:

1. A method comprising:
receiving a request for an advertisement in a set of advertisements;
upon receiving the advertisement request, determining whether user-campaign match data for the set of advertisements and a set of users has been previously determined; and
in response to determining that user-campaign match data has previously been determined, selecting an advertisement with which to respond to the request using the previously determined user-campaign match data.

2. The method of claim 1, further comprising, in response to determining that the user-campaign match data has not been previously determined, determining the user-campaign match data including one or more matches between a set of one or more users and the set of advertisements.

3. The method of claim 1, further comprising storing the user-campaign match data in at least one bitset, wherein each advertisement in the set of advertisements corresponds to a different position in the at least one bitset.

4. The method of claim 3, further comprising, for each advertisement, storing, in at least another bitset, an identifier of the advertisement in association with the advertisement's corresponding position in the at least one bitset.

5. The method of claim 4, further comprising:
determining a user associated with the request;
determining a bitset from the at least one bitset corresponding to the user;
determining one or more positions in the determined bitset indicating a match; and
identifying one or more advertisements corresponding to the one or more positions using the at least another bitset.

6. The method of claim 5, wherein the user-campaign match data is stored in a plurality of bitsets, each bitset corresponding to a different user in the set of users and wherein the plurality of bitsets are stored in a hash map keyed to user identifiers corresponding to each user in the set of users.

7. The method of claim 4, further comprising:
determining that an advertisement has been removed from the set of advertisements; and
storing an indicator in a position of the bitmap corresponding to the removed advertisement indicating that the position is empty.

8. The method of claim 4, further comprising:
determining that a new advertisement is to be added;
determining a position in the bitmap having an empty indicator; and
storing an identifier of the new advertisement in the determined position having the empty indicator.

9. The method of claim 1, further comprising:
prior to receiving the request, dividing the set of advertisements into a plurality of subsets, wherein selecting an advertisement with which to respond to the request using the previously determined user-campaign match data includes:
selecting at least one subset from the plurality of subsets, wherein only the user-campaign match data of the advertisements in the selected at least one subset is used to select the advertisement.

10. The method of claim 1, further comprising:
determining a probability that the advertisement will be sent to a user associated with the request a number of times within a specified period of time exceeding a predefined limit;
determining whether the probability exceeds a threshold probability; and
in response to determining that the probability exceeds the threshold probability, storing transmission frequency data for the advertisement.

11. The method of claim 10, wherein the stored transmission frequency data includes only a transmission frequency of the advertisement to the user.

12. The method of claim 10, wherein the probability is determined prior to receiving the advertisement request.

13. A method comprising:
dividing a set of advertisements into a plurality of subsets, wherein each subset is smaller than the set;
receiving an advertisement request;
selecting at least one subset from the plurality of subsets; and
determining one or more advertisements matching the request by comparing one or more advertisements in the selected at least one subset to the request.

14. The method of claim 13, wherein dividing the set of advertisements into the plurality of subsets is based on a percentage of a user population that each advertisement in the set of advertisements matches.

15. The method of claim 13, wherein dividing the set of advertisements into the plurality of subsets is based on one or more display parameters of each advertisement in the set of advertisements.

16. The method of claim 13, wherein the request includes demographic information of a user associated with the request.

17. A method comprising:
determining a probability that an advertisement will be sent to a user a number of times, over a specified period of time, exceeding a predefined limit;
determining whether the probability exceeds a threshold probability; and
in response to determining that the probability exceeds the threshold probability, storing transmission frequency data for the advertisement.

18. The method of claim 17, wherein in response to determining that the probability does not exceed the threshold probability, not storing the transmission frequency data.

19. The method of claim 17, further comprising:
determining a usage pattern of the user; and
categorizing the user according to the determined usage pattern, wherein determining the probability that the advertisement will be sent to the user a number of times, over the specified period of time, exceeding a predefined limit is based on the determined usage pattern.

20. The method of claim 17, wherein the threshold probability corresponds to a confidence level.

21. The method of claim 17, wherein the transmission frequency data of the advertisement only includes transmission frequency data of transmissions of the advertisement to the users in the category of users during the specified period of time.

22. An apparatus comprising:
a processor; and
memory configured to store computer readable instructions that, when executed, causes the processor to perform a method comprising:
determining a probability that an advertisement will be sent to a user a number of times, over a specified period of time, exceeding a predefined limit;
determining whether the probability exceeds a threshold probability; and
in response to determining that the probability exceeds the threshold probability, storing transmission frequency data for the advertisement.

23. The apparatus of claim 22, wherein in response to determining that the probability does not exceed the threshold probability, not storing the transmission frequency data.

24. The apparatus of claim 22, the memory further configured to store instructions for:
determining a usage pattern of the user; and
categorizing the user according to the determined usage pattern, wherein determining the probability that the advertisement will be sent to the user a number of times, over the specified period of time, exceeding a predefined limit is based on the determined usage pattern.

25. An apparatus comprising:
a processor; and
memory configured to store computer readable instructions that, when executed, causes the processor to perform a method comprising:
dividing a set of advertisements into a plurality of subsets, wherein each subset is smaller than the set;
receiving an advertisement request;
selecting at least one subset from the plurality of subsets; and
determining one or more advertisements matching the request by comparing one or more advertisements in the selected at least one subset to the request.

26. The apparatus of claim 25, wherein dividing the set of advertisements into the plurality of subsets is based on a percentage of a user population that each advertisement in the set of advertisements matches.

27. The apparatus of claim 25, wherein dividing the set of advertisements into the plurality of subsets is based on display frequency requirements of each advertisement in the set of advertisements.

28. An apparatus comprising:
a processor; and
memory configured to store computer readable instructions that, when executed, causes the processor to perform a method comprising:
receiving a request for an advertisement in a set of advertisements;
upon receiving the advertisement request, determining whether user-campaign match data for the set of advertisements and a set of users has been previously determined; and
in response to determining that user-campaign match data has previously been determined, selecting an advertisement with which to respond to the request using the previously determined user-campaign match data.

29. The apparatus of claim 28, the memory further configured to store instructions for, in response to determining that the user-campaign match data has not been previously determined, determining the user-campaign match data including one or more matches between a set of one or more users and the set of advertisements.

30. The apparatus of claim 29, the memory further configured to store instructions for, for each advertisement, storing, in a bitmap, an identifier of the advertisement in association with the advertisement's corresponding position in the at least one bitset

31. One or more computer readable media storing computer readable instructions that, when executed by a processor, cause the processor to perform a method comprising:
determining a probability that an advertisement will be sent to a user a number of times exceeding a predefined limit;
determining whether the probability exceeds a threshold probability; and
in response to determining that the probability exceeds the threshold probability, storing transmission frequency data for the advertisement.

32. The one or more computer readable media of claim 31, wherein in response to determining that the probability does not exceed the threshold probability, not storing the transmission frequency data.

33. The one or more computer readable media of claim 31, further comprising instructions for:
determining a usage pattern of the user; and
categorizing the user according to the determined usage pattern, wherein determining the probability that the advertisement will be sent to the user a number of times exceeding a predefined limit is based on the determined usage pattern.

34. One or more computer readable media storing computer readable instructions that, when executed by a processor, cause the processor to perform a method comprising:
dividing a set of advertisements into a plurality of subsets, wherein each subset is smaller than the set;
receiving an advertisement request;
selecting at least one subset from the plurality of subsets; and
determining one or more advertisements matching the request by comparing one or more advertisements in the selected at least one subset to the request.

35. The one or more computer readable media of claim 34, wherein dividing the set of advertisements into the plurality of subsets is based on a percentage of a user population that each advertisement in the set of advertisements matches.

36. The one or more computer readable media of claim 34, wherein dividing the set of advertisements into the plurality of subsets is based on display frequency requirements of each advertisement in the set of advertisements.

37. One or more computer readable media storing computer readable instructions that, when executed by a processor, cause the processor to perform a method comprising:
receiving a request for an advertisement in a set of advertisements;
upon receiving the advertisement request, determining whether user-campaign match data for the set of advertisements and a set of users has been previously determined; and
in response to determining that user-campaign match data has previously been determined, selecting an advertisement with which to respond to the request using the previously determined user-campaign match data.

38. The one or more computer readable media of claim 37, further comprising instructions for, in response to determining that the user-campaign match data has not been previously determined, determining the user-campaign match data including one or more matches between a set of one or more users and the set of advertisements.

39. The one or more computer readable media of claim 37, further comprising instructions for, for each advertisement, storing, in a bitmap, an identifier of the advertisement in association with the advertisement's corresponding position in the at least one bitset.
